(19) United States
(12) Patent Application Publication
(10) Pub. No.: US 2001/0004769 A1
(43) Pub. Date: Jun. 21, 2001

(54) Cable/satellite/internet-ready television set

(76) Inventor: Rudy J. Simon, Dexter, ME (US)

Correspondence Address: THOMAS L. BOHAN & ASSOCIATES, 371 FORE STREET, SUITE 202, PORTLAND, ME, 04101, US

(21) Appl. No.: 09/755,500

(22) Filed: Jan. 5, 2001

Related U.S. Application Data
(63) Continuation-in-part of application No. 09/401,579, filed on Sep. 22, 1999, now Pat. No. 6,172,702.

(51) Int. Cl. H04N 7/16; H04N 7/173

(52) U.S. Cl. 725/108; 725/133; 725/141; 725/153

(57) ABSTRACT

A cable/satellite/Internet-ready television set. The main satellite chassis is incorporated into the television set and is linked to the inputs and outputs on the main television chassis. A cable/satellite/Internet control panel is integrated into the television cabinet and is accessible to the user on the front of the cabinet. The cable/satellite/Internet control panel has a satellite access card slot and control buttons, as well as an infrared signal input for a remote control device. The television set comes equipped with a single remote control device that will allow the user to select the mode of transmission (radio frequency broadcast, cable, satellite, broadband data, etc.) and the channel, as well as control other television functions such as controlling the volume and turning the television set on or off. In several embodiments, a credit/debit card reader is incorporated within the television set either in the cabinet or the remote control device.

This is a continuation-in-part of U.S. application Ser. No. 09/401,579, filed Sep. 22, 1999.

### BACKGROUND OF THE INVENTION

1. Field of the Invention

This invention relates to a television set. More particularly, the present invention relates to a television set equipped with a tuner capable of receiving television signals that are of three general classes: radio-frequency (RF) broadcast signals, signals transmitted by cable, and signal transmitted by satellite. Yet more particularly, this invention relates to such a television set that does not require external tuner boxes. Yet more particularly still, the present invention relates to such a television set capable of being operated through the use of a single set of controls such as on a single remote control device. Finally, the present invention relates to such a television set that has a credit card reader integrated within, or alternately within such a remote control device.

2. Description of Related Art

At one time, television signals were radio-frequency (RF) signals broadcast through the air either as very high frequency (VHF) signals, or as ultra high frequency (UHF) signals. Initially, only twelve VHF channels were broadcast. Within a few years, numerous channels of UHF television signals were being broadcast in addition to the VHF channels. Today, there are hundreds of channels of RF television signals being broadcast via a number of media, including the airwaves, via cable or satellite systems, and now the World Wide Web by means of the Internet.

Originally, television sets were equipped with a tuner and a dial that could handle the twelve VHF channels. A second dial was added to enable the viewer to select a VHF or UHF channel. Nowadays, television sets may have several external tuner boxes, generally stacked on top of one another on the top of the sets: one or more to receive the numerous RF channels, one or more to receive the many cable channels, and one for the satellite channels. These external tuner boxes along with the requisite cables to hook them to the television set are prone to disarray. Each such external tuner box requires its own set of controls and each external tuner box interfaces with the channel-selection circuitry within the television set itself. Given this situation, it is desirable to have a television set capable of receiving broadcast RF signals, signals transmitted by cable (including optical cable), Internet signals (e.g., Web-TV), and signals transmitted by satellite. It is further desirable to have such a television set that is controlled through the use of a single set of controls on the television set itself so that external tuner boxes and connecting cables can be eliminated.

Cable television and the World Wide Web have presented viewers with the opportunity to purchase desired television programs (e.g., “Pay-per-View”), as well as advertised goods. At present, a viewer who desires to make such a purchase typically places a telephone call to an advertised telephone number, and then reads his or her credit card number to the person on the other end. Similarly, a call may be made to the customer's cable company to purchase movies, sports telecasts, and other pay-per-view programming. This process, needlessly cumbersome from the perspective of the viewer, nevertheless is all present viewers have to resort to.

There have been prior-art attempts to resolve some of the above-described deficiencies. For example, DeVilbiss (U.S. Pat. No. 4,737,993; issued 1988) discloses a tuning device capable of switching between broadcast and cable television transmissions, and simultaneously accommodating the different channels associated with the two broadcast modes. The DeVilbiss device, however, does not meet today's needs in that it is not capable of receiving and handling satellite television transmissions.

A television tuner that is capable of receiving broadcast and cable television transmissions and that is fully integrated on a single, physically small microcircuit capable of being produced inexpensively is taught by Rotzoll (U.S. Pat. No. 5,737,035; issued 1998). As with the DeVilbiss device, the Rotzoll device is also incapable of handling satellite television transmissions.

Chimoto et al. (U.S. Pat. No. 5,838,383; issued 1998) discloses a multimedia television receiver capable of receiving signals in a wide variety of transmission and digital formats. This invention is designed to incorporate a personal computer and video display into a unit capable of displaying both television signals and computer output. Although the Chimoto et al. device is capable of handling satellite transmissions, it is a complex and expensive device that requires a computer to control the display as well as input and channel selection.

A satellite receiver that has a credit card reader incorporated there within is taught by Ozaki (U.S. Pat. No. 5,601,581; 1997). Because the Ozaki device is essentially a stand-alone receiver box and separate from a television that it is used in conjunction with, the problems associated with the above-mentioned receivers are still present, including in particular, the unpleasantness associated with the need for multiple connection cables.

Therefore, what is needed is a television set capable of receiving television signals from broadcast RF signals, cable systems, and satellite systems in an integrated fashion so that the television set requires no external tuner boxes. What is further needed is such a television set that requires for all modes of television reception but one set of controls, mounted within the chassis of the television set. What is still yet further needed is such a television set that is controlled by a remote control device. What is additionally needed is such a television set that has an integrated facility that the viewer can use to conveniently make purchases of items associated with or presented on the television.

### SUMMARY OF THE INVENTION

The present invention provides a television set capable of receiving broadcast RF signals, cable television signals, and satellite signals. Moreover, in exemplary embodiments, the present invention provides such a television set that is capable of receiving signals from additional sources including the Internet. The present invention, moreover, provides such a television set that is contained within a single enclosure. More importantly, the present invention provides such a television set that contains within a single box the television display means and all of the circuit modules for broadcast signals, cable signals, and satellite signals. Additionally, the present invention provides a television set that is linked to or is manipulated by a single remote control device capable of activating all of the operations of signal-reception. Finally, the present invention provides the viewer with means to purchase “pay-per-view” programming and other services and goods—including notably, games from specific vendors such as Sony, Sega, and Nintendo—directly through an integrated facility.

The present invention includes a cable/satellite/Internet-ready television set having a single set of controls that the viewer uses to select from among the following: (1) a mode of transmission, including RF broadcast, cable, phone line, satellite, or external video game; and, (2) a desired channel or Web address (Uniform Resource Location [URL]). The television is equipped with a main television chassis that has inputs for antenna, cable, video (including those for video games, including but not limited to Sony's PlayStation 2, Nintendo 64, and Sega Genesis), audio, and satellite. In exemplary embodiments, inputs for Ethernet and/or other broadband signals connections are provided.

It will be understood that within the scope of the present invention, the cable signal transmission mode is capable of conveying both television signals and Internet signals. The term “television” as used herein includes reference to High Definition television (HDTV). Furthermore, as used herein, the term “cable” includes reference to coaxial cable, Composite-video cable, S-video cable, Component-video cable, and optical cable. It will be further understood that, within the scope of the present invention, the Internet may be accessed by different means including, by way of non-limiting example, Ethernet, phone line, cable, and satellite receiver. Finally, the scope of the present invention anticipates that new cable formats for television and video signals will be developed. Therefore, the present invention will have increased utility as these new cable formats are developed.

According to the present invention, the main television chassis has a power cord, and feeds the incoming signal to the television tuner/demodulator. It is possible, of course, that, a cable-ready television may be equipped with a main television chassis and a main satellite chassis. In such a case, the television signal comes in to the main television chassis, which is connected to the satellite, cable, or antenna system.

The scope of the present invention includes both a class of embodiments in which a television set is equipped with a main television chassis and a main satellite chassis, as well as a class of embodiments in which a television is equipped with only a main television chassis that receives incoming RF, cable, and/or satellite, signals and then feeds the television signal to the television tuner/demodulator.

The television set of the present invention is equipped with a satellite system access means. In some embodiments this access means is an access card assembly. This access card assembly, which includes a receiver slot for the satellite access card, is connected to the digital satellite receiver on the main satellite chassis. A cable/satellite/Internet control panel which contains transmission-mode/channel-selection controls is mounted on the front of the television set and also connected to the digital satellite receiver input on the main satellite chassis. This cable/satellite/Internet control panel can be activated by the user via a single remote control device or via manual controls (e.g., push-buttons, heat and/or electrical conductivity sensitive LCD screen, etc.). The satellite system access card assembly and cable/satellite control panel are contained within the television cabinet, as are the main television chassis and the main satellite chassis with the digital satellite receiver input.

The present invention further provides for a credit/debit card reading device with which a viewer may conduct transactions including, by way of non-limiting example, purchasing pay-per-view programming, purchasing video games to down load over a transmission source from vendors, purchasing goods over home-shopping channels (e.g., the Home Shopping Network, QVC, etc.), and purchasing goods over Web-TV. The credit card reader is, typically, of the type that reads the account information from the magnetic strip on the back of the credit/debit card; however, optical reading devices that read alphanumeric or holographic information stored on the credit/debit card are within the scope of the present invention.

Regarding the placement of the credit/debit card reader, it may be incorporated within the television chassis or within the remote control. Depending on embodiments, the information “read” by the card reader may be transmitted to both the card-account institution and the vendor (of services/products being bought) over the same mode of transmission as the television signals or over a different mode of transmission. To illustrate the latter embodiment, a viewer intending to purchase a pay-per-view program could “swipe” his or her credit/debit card through a card reader incorporated into a remote control device that has cellular phone capabilities, while the television controlled by the remote control is receiving television signals over an optical cable network. In this case the credit/debit card information would be relayed over a cellular phone network, while the pay-per-view program would be received over another network, i.e., optical cable.

The user selects the desired RF/cable/satellite transmission mode by use of the the remote control device, and then uses the remote control to select the desired mode and channel. It is possible to manually select the desired mode and channel by pressing the MENU button on the cable/satellite/Internet control panel and using the position buttons to make a selection.

A satellite access card receiver assembly is mounted within the television cabinet. The user can insert an access card into a card slot that is integrated into the television cabinet. The modem connection provided on the main television chassis allows the user to dial up the satellite system server to order services and allows the system server to record information from the card for billing purposes.

In those embodiments that have a remote control device, a cellular phone can be built into such a remote control. The term “cellular phone” refers to any wireless system having both a transmitter and a receiver, or just a transmitter by itself.

The television set of the present invention encompasses three well-known video display means: cathode-ray picture tubes (CRTs), liquid crystal displays (LCDs), as well as wide screen projectors. With flat-screen televisions, such as those using LCDs, the question of where to place the various tuner boxes arises, as there is no cabinet on which to set them. Thus, one advantage of the television set of the present invention is ease of use. The user of the present invention need only select a desired mode of signal transmission and a channel/URL, using only a single control panel that is integrated within the cabinet of the television set and/or remote control device (or that is provided as a separate single control box in the case of a flat-screen television.)

Regarding additional benefits, the user of the present invention is provided considerable convenience when hooking up the television set because it has only a single control box and single power cord. Economical benefits accrue through use of the present invention because because fewer external tuner boxes with their connecting cables and power cables need be manufactured. Finally, in addition to the previously mentioned advantages, the television set of the present invention eliminates the esthetic drawbacks of the prior art by doing away with the numerous unsightly tuner boxes stacked on top of the television cabinet or on the floor, along with the tangle of power and connecting cords.

### DESCRIPTION OF THE ILLUSTRATIONS

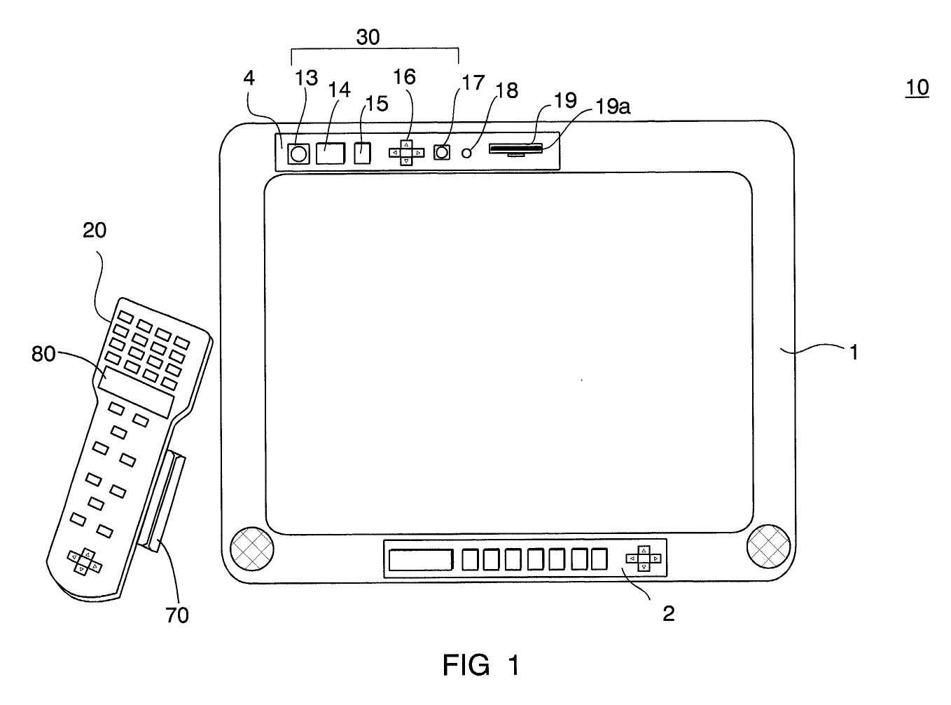

FIG. 1 is a front view of a television set equipped with the main television chassis and the main satellite chassis of the present invention.

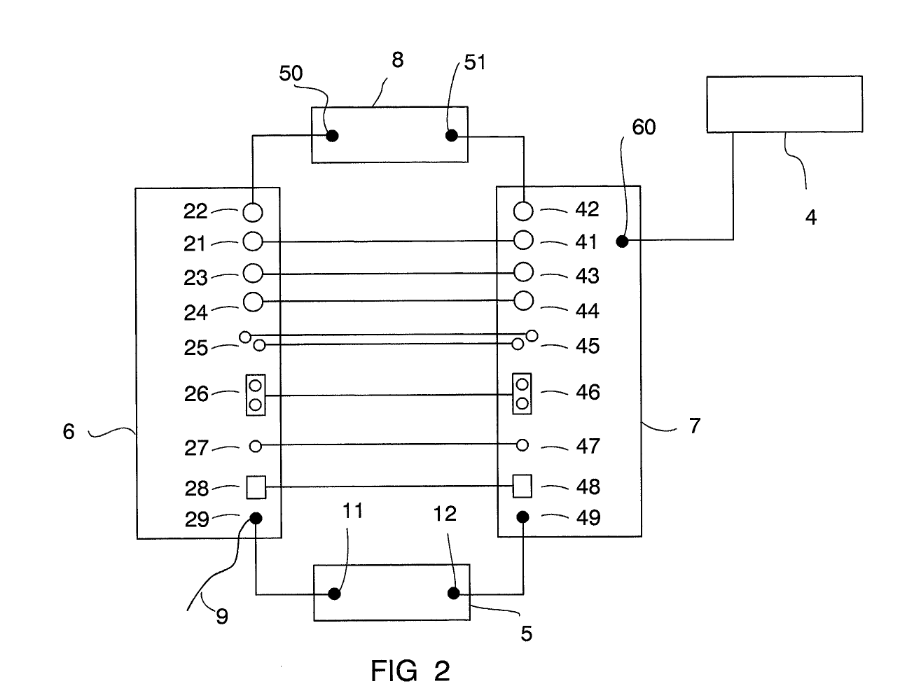

FIG. 2 is a block diagram of the main television chassis and the main satellite chassis of the present invention, showing the inputs on the main television chassis and the connections to the main satellite chassis.

FIG. 3 shows a credit/debit card reader integrated with remote control device of the present invention.

FIG. 4 is a block diagram of the remote control device including the credit/debit card reader and cellular phone section.

### DETAILED DESCRIPTION OF THE PREFERRED EMBODIMENT

The Preferred Embodiment of the present invention includes a cable-satellite-ready television set 10, a front view of which is shown in FIG. 1. A schematic diagram of the connections for receiving the RF, cable, and satellite signals is shown in FIG. 2.

Referring to FIG. 1, it can be seen that the television set 10 is equipped with a standard television control panel 2 and speakers 3. In addition, the television set 10 has a transmission-mode/channel/URL-control panel 4 that is integrated into a cabinet 1 of the television set 10. The transmission-mode/channel/URL control panel 4 includes a satellite-on/off-message-indicator 13, a series of manual control buttons 30, an infrared receiver for remote control 18, and a satellite access card slot 19. The manual control buttons 30 include a select-and-display button 14, a television/satellite/Internet selection button 15, four directional buttons 16, and a menu button 17. These are provided for manual selection of the transmission mode and channel/URL.

A main television chassis 6, a main satellite chassis 7, a standard television tuner/demodulator 8, and a power supply 5 are built into the television set 10. As can be seen in the schematic diagram shown in FIG. 2, the main television chassis 6 of the Preferred Embodiment has a series of inputs that includes a first antenna input 21, a first superior-video (S-video) input 23, a first video input 24, a first pair of audio inputs 25, a first broadband-data-input 26, a first satellite input 27, a first modem connector 28, and a first alternating current (a/c) power input 29. An a/c power source 9 is connected to the first a/c power input 29, and that in turn is connected via an internal power supply 5 to a second a/c power input 49 on the main satellite chassis 7. The main television chassis 6 also has a first television output 22 that is connected to the tuner/demodulator 8, shown in FIG. 2 at 50.

Each of the inputs and the output on the television main chassis 6 is connected to a corresponding second input or output on the main satellite chassis 7. Thus, the first antenna input 21 is connected to a second antenna input 41, the first S-video input to a second S-video input 43, the first video input 24 to a second video input 44, the first pair of audio inputs 25 to a second pair of audio inputs 45, the first broadband-data-input 26 to a second broadband-data-input 46, the first satellite input 27 to a second satellite input 47, and the first modem connector 28 to a second modem connector 48. The first television output 22 is also connected to a second television output 42, that in turn is also connected to the tuner/demodulator 8, shown in FIG. 2, at 51. The transmission-mode/channel-selection panel 4, shown in FIG. 1, is connected to a digital satellite receiver 60 on the main satellite chassis 7. The connections from the transmission-mode/channel-selection panel 4 are well-known in the field and are not described herein in any detail as those connections are not included within the scope of the present invention.

The user will typically control the television set by means of a remote control 20, shown in FIG. 1. With the use of this remote control device 20, the user will be able to select the desired mode of television signal transmission (rf, cable, satellite) and the channel, video or S-video, or broadband-data-input, as well as execute other well-known functions, such as turning the television set 10 on or off, controlling the volume or the video, and so forth. The remote control device 20 also includes a credit/debit card reader 70, which in the Preferred Embodiment is of the ‘swipe’ type attached to the remote control device 20. Moreover, the remote control device 20 includes a cellular phone section 80 that enable a the credit/debit card reader 70 to transmit and receive data.

FIG. 3 shows the a credit/debit card reader 70 incorporated into the remote control device 20. A cellular phone section 80 is also shown integrated into the remote control device 20. A block diagram of the remote control device 20 with the credit/debit card reader 70 and cellular phone section is shown in FIG. 4.

While a Preferred Embodiment is disclosed, this is not intended to be limiting. Rather, the general principles set forth herein are considered to be merely illustrative of the scope of the present invention and it is to be further understood that numerous changes may be made without straying from the scope of the present invention.

What is claimed is:

1. A cable/satellite/Internet-ready television set comprising:
a television cabinet;
a television screen, said television screen being built into said television cabinet;
a television control panel, said television control panel being built into said television cabinet, said television control panel including a transmission-mode/channel selection panel;
a television tuner/demodulator, said television tuner/demodulator being built into said television cabinet, said television tuner/demodulator having a first tuner/demodulator input and a second tuner/demodulator input; and
a credit/debit card reader in communication with said television set.

2. The cable/satellite/Internet-ready television set of claim 1 further comprising:
a main television chassis, said main television chassis being built into said television cabinet, said main television chassis having a first alternating current (a/c) power input connector, said first a/c power input connector being connected to an internal television power supply unit, said main television chassis having a first television output connection and a series of first input connections, wherein alternating current from an external power source is applied to said first a/c power input connector; and
a main satellite chassis, said main satellite chassis being built into said television cabinet, said main satellite chassis having a second a/c power input connector, said second a/c power input connector being connected to said internal television power supply unit, said main satellite chassis having a second output connection and a series of second input connections, said main satellite chassis having a satellite receiver;
wherein said main television chassis output is connected to said first tuner/demodulator input and said main satellite chassis output is connected to said second tuner/demodulator input.

3. The cable/satellite/Internet-ready television of claim 2, wherein said series of first input connections includes a first pair of audio inputs, at least one first cable input, and a first satellite input;
wherein said series of second input connections includes a second pair of audio inputs, at least one second cable input, and a second satellite input; and
wherein each input of said series of first input connections is connected to a corresponding input of said series of second input connections.

4. The cable/satellite/Internet-ready television of claim 3, wherein said transmission-mode/channel selection panel includes a satellite access card slot and a plurality of transmission-mode/channel selection controls, said satellite access card slot and said plurality of transmission-mode/channel selection controls being connected to said satellite receiver.

5. The cable/satellite/Internet-ready television of claim 3, wherein said series of first input connections comprise a first superior video (S-Video) input, and wherein said series of second input connections comprises a second superior video (S-Video) input.

6. The cable/satellite/Internet-ready television of claim 3, wherein said series of first input connections comprise a coaxial cable input, and wherein said series of second input connections further comprise a second coaxial cable input.

7. The cable/satellite/Internet-ready television of claim 3, wherein said series of first input connections further comprises a first modem input, and wherein said series of second input connections further comprise a second superior video modem input.

8. The cable/satellite/Internet-ready television of claim 3, wherein said series of second input connections further comprises a first antenna input, and wherein said series of second input connections further comprise a second antenna input.

9. The cable/satellite/Internet-ready television of claim 1, wherein said credit/debit card reader is incorporated within said television cabinet.

10. The cable/satellite/Internet-ready television of claim 1, further comprising a remote control device, said remote control device being capable of selecting a transmission mode.

11. The cable/satellite/Internet-ready television of claim 10 wherein said credit/debit card reader is incorporated within said remote control device.

12. The cable/satellite/Internet-ready television of claim 11, said remote control device further comprising a cellular phone.

13. A television set comprising:
a television cabinet;
a television screen, said television screen being built into said television cabinet;
a television control panel built into said television cabinet, said television control panel includes a transmission-mode/channel selection panel;
a television tuner/demodulator, said television tuner/demodulator being built into said television cabinet, said television tuner/demodulator having a first tuner/demodulator; and
a credit/debit card reader in communication with said television cabinet.

14. The televisions set of claim 13 wherein said credit/card reader is integrated within said television cabinet.

15. The television set of claim 13 further comprising:
a main television chassis, said main television chassis being built into said television cabinet, said main television chassis having a first alternating current (a/c) power input connector, said first a/c power input connector being connected to an internal television power supply unit, said main television chassis having a first television output connection and a series of first input connections, wherein alternating current from an external power source is applied to said first a/c power input connector;
wherein said main television chassis output is connected to said first tuner/demodulator input.

16. The cable/satellite/Internet-ready television of claim 15, wherein said series of first input connections includes a first pair of audio inputs, at least one first cable input, and a first satellite input.

17. The cable/satellite/Internet-ready television of claim 16, wherein said transmission-mode/channel selection panel includes a satellite access card slot and a plurality of transmission-mode/channel selection controls, said satellite access card slot and said plurality of transmission-mode/channel selection controls being connected to said satellite receiver.

18. The cable/satellite/Internet-ready television of claim 13 further comprising a remote control device, said remote control device being capable of selecting a transmission mode.

19. The cable/satellite/Internet-ready television of claim 18, wherein said credit/debit card reader is integrated with said remote control device.

20. The cable/satellite/Internet-ready television of claim 19, said remote control device further comprising a cellular phone.
